(19) United States
(12) Patent Application Publication
(10) Pub. No.: US 2013/0254011 A1
(43) Pub. Date: Sep. 26, 2013

(54) METHOD AND SYSTEM FOR DISTRIBUTION OF DIGITAL CONTENT

(71) Applicant: Thomas Mark Lloyd Brooke, Portland, OR (US)

(72) Inventor: Thomas Mark Lloyd Brooke, Portland, OR (US)

(21) Appl. No.: 13/838,958

(22) Filed: Mar. 15, 2013

Related U.S. Application Data
(60) Provisional application No. 61/613,988, filed on Mar. 22, 2012.

(51) Int. Cl. G06Q 30/02

(52) U.S. Cl. CPC G06Q 30/0272
USPC 705/14.35

(57) ABSTRACT

This disclosure provides a method and system for distributing digital content utilizing defined and dynamically displayed start and end dates for a sale, configurable pricing options, the dynamic display of sales data, the option to include a charity of choice and the setting of a sales goal or goals with incentives released or provided to purchasers when the sales goal or goals are achieved.

### BACKGROUND

With the advent of the Internet, distribution of digital content, such as digital music, games, video and the like, exploded. This provided, initially, a great commercial opportunity and channel for content producers. Digital stores such as iTunes® and Amazon.com leveraged scale with the inherent advantages of digital content (i.e. no scarcity, high margins) to generate massive revenues.

But the same aspects that made the Internet such a great distribution system for digital content also undermined its commercial foundation. Digital content can easily be copied and, through peer-to-peer sharing across a global distribution channel that is virtually impossible to police, mass pirated as fast as it can be legally distributed.

In order to try to combat piracy, content owners and digital distributors have tried to utilize software in the form of various DRM (“Digital Rights Management”) solutions. Over time, DRM has proven highly ineffective as consumers find ways to defeat or work around the restrictions. It is estimated that in 2008 $75 billion of pirated digital content was downloaded from the Internet. That number is predicted to triple by 2015.

Piracy has become so widespread and the ability to block it through DRM or stop it through enforcement so ineffective that the industry has adapted to various free-models supported by an underlying ad-based business model. Streaming services such as Pandora or Spotify for music and Hulu for video are popular with consumers, however, the sustainability of the business models is in question as the companies consistently lose significant amounts of money and the content owners, themselves, are getting paid little or nothing for their work.

There is a need for a new method and system for distribution of digital content.

### SUMMARY

This Summary is provided to introduce a selection of concepts in a simplified form that are further described below in the Detailed Description.

This disclosure provides a method and system for distributing digital content utilizing defined and dynamically displayed start and end dates for a sale, configurable pricing options, the dynamic display of sales data, the option to include a charity of choice and the setting of a sales goal or goals with incentives released or provided to purchasers when the sales goal or goals are achieved.

The foregoing and other features and advantages of the disclosure will become more apparent from the following detailed description, which proceeds with reference to the accompanying figures.

### BRIEF DESCRIPTION OF THE DRAWINGS

FIG. 1 is a block diagram depicting an example system including a user interface, processor and database for distributing digital content utilizing defined and dynamically displayed start and end dates for a sale, configurable pricing options, dynamic display of sales data, the option to include a charity of choice and the setting of a sales goal or goals with an incentive or incentives released to purchasers when the sales goal or goals are achieved.

FIG. 2 is a block diagram depicting work flow in an example system for distributing online digital content in accordance with a disclosed embodiment.

FIG. 3 is a block diagram depicting work flow in an example system for distributing online digital content in accordance with an additional disclosed embodiment.

FIG. 4 is a block diagram illustrating an example computing device in conjunction with which techniques and tools described herein may be implemented.

FIG. 5 is a screenshot depicting workflow for scheduling a sale of digital content utilizing the disclosed embodiment.

FIG. 6 is a screenshot depicting workflow for uploading digital content and configuring a sale utilizing the disclosed embodiment.

FIG. 7 is a screenshot depicting workflow for setting a sales goal and assigning an incentive to be released when the sales goal is achieved utilizing the disclosed embodiment.

FIG. 8 (a), (b) are screenshots depicting workflow for selecting whether to include a charity and, if yes, then selecting the charity, the amount to give and whether to include a top donor competition with awards, utilizing the disclosed embodiment.

FIG. 9 is a screenshot depicting the published webpage utilizing the disclosed embodiment.

FIGS. 10, 11, 12, and 13 are example screenshots that depict a web page for distributing digital content during an example online promotion.

### DETAILED DESCRIPTION

This disclosure provides a method for distributing digital content. In some embodiments, the method includes setting up a sale by selecting specific start and end dates. By limiting the time period associated with a specific sale and displaying this dynamically, a sense of urgency is created which encourages users to purchase lest they miss out on the sale.

In some embodiments, the method includes configurable pricing options including setting a fixed price or a Pay What You Want option. Pay What You Want allows customers to input whatever amount they wish to pay for the digital content.

In some embodiments, the method includes storing and dynamic display of select sales data such as total units sold, amount of money paid by all users, average price paid by users, if charity is included and how much money has been raised for charity. In this embodiment, dynamic display means that the system stores and processes the select sales data for display at the point of purchase. Alternatively, the system could integrate with a third-party application that processes and stores the sales data and reports back to the system the data to be dynamically displayed. So, for instance, if a purchase occurs while a user is at the point of purchase, e.g. a webpage, then the system stores and processes the resulting sales data or receives the data from an integrated third-party application and dynamically displays the select data without further user interaction (e.g. clicking a button or refreshing the webpage). By publishing sales data in a transparent way, users gain a sense of trust and feel connected to the promotion. Dynamic display of sales data further supports two other embodiments of the invention.

In some embodiments, the method includes utilizing the setting of a sales goal or goals with an incentive or incentives provided to purchasers when the sales goal or goals are achieved. Sales goals can be defined by total units sold, total revenue generated, amount of money raised for charity, the price paid by a user, and the like. Incentives can include additional digital content, streaming video, digital coupons or other items or experiences. Since the invention allows users to see the sales data dynamically displayed, they can track the status of the sales goal or goals. Since reaching a defined sales goal means purchasers receive an additional incentive, it encourages both purchases as well as purchasers sharing the promotion with others so that the goals are achieved. If a sales goal is achieved, then the incentive is unlocked, and the system automatically distributes or makes available the incentive to purchasers.

In some embodiments, the method also allows the option to include a charity and, if included, to select a charity of choice and determine the percentage of sales revenues to allocate to the selected charity. When charity is included, the method also provides the option to include a top donor competition where the system processes and dynamically displays top donors and the amounts they donated along with the prizes at stake. People donate to cause for a variety of reasons including to establish reputation with their peers. By displaying donation amounts and recognizing top donors, the system reinforces one of the primary motivations for giving.

An advantage of the disclosure is that it combats piracy by creating an incentive for people to want to pay for digital content.

The disclosed methods and systems may be implemented on various computing systems or devices including server computers, minicomputers, mainframe computers, distributed computing environments that include any of the above systems or devices, and the like. The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

Referring to the drawings, like numbers indicate like parts through the views. In this document, relational terms such as first and second, top and bottom, and the like may be used solely to distinguish one entity or action from another entity or action without necessarily requiring or implying any actual such relationship or order between such entities or actions.

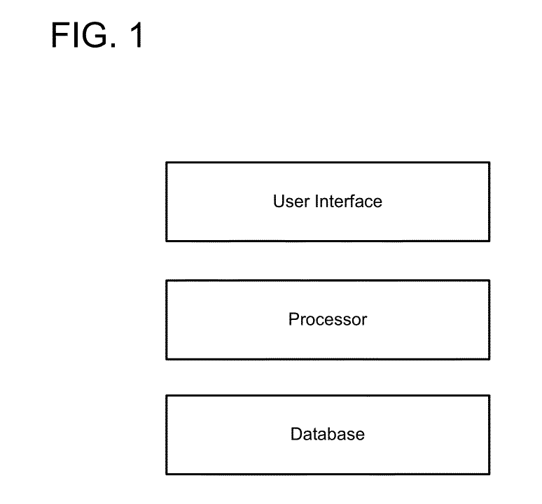

As illustrated in FIG. 1 a system for distributing online digital content in accordance with a disclosed embodiment can include the (a) a user interface component, (b) a processor component, and (c) a database. As will be described in additional detail herein, among other functionality the user interface component generates an interface to allow a user to setup online distribution of digital content. The processor component processes the various options available to the user for setting up distribution and processes sales data and displays dynamically. The database stores the selections made by users when they setup distribution of the digital content and, as well, stores the digital content sold.

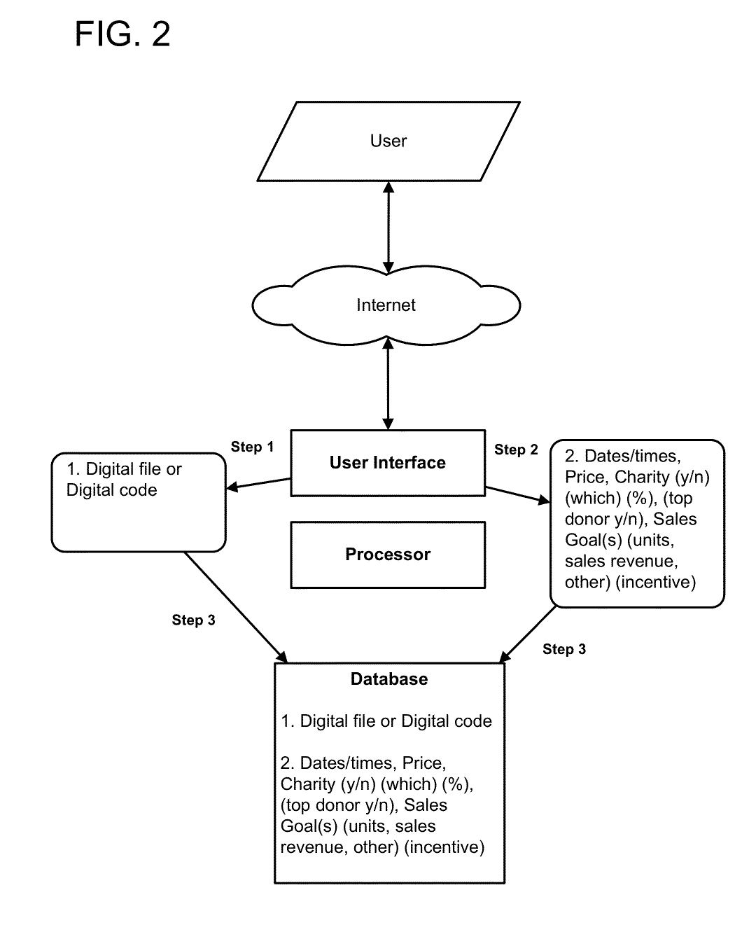

In use, a user accesses the system through a computer system, mobile phone, pad or similar device that connects to the Internet. See FIG. 2. From the user interface component, the user is provided via the processor component with the option to upload digital content to the database and/or input data that can be used to access digital content stored on a separate computer system. See Step 1. From the same user interface, the user is provided options for distributing the digital content. Options can include (a). setting dates/times, (b). setting a fixed price or selecting pay what you want, (c). whether to include a charity, and if yes, then choosing a charity, allocating a percentage of sale revenue to the selected charity, choosing whether to include a top donor competition and defining the prizes associated with this competition (d). setting a sales goal, by total units sold, total sales revenue, individual amount paid, or an equivalent and defining an incentive that can be provided to purchasers if the goal is met. See Step 2. In some embodiments, data from Step 1 and Step 2 are stored in the database. See Step 3.

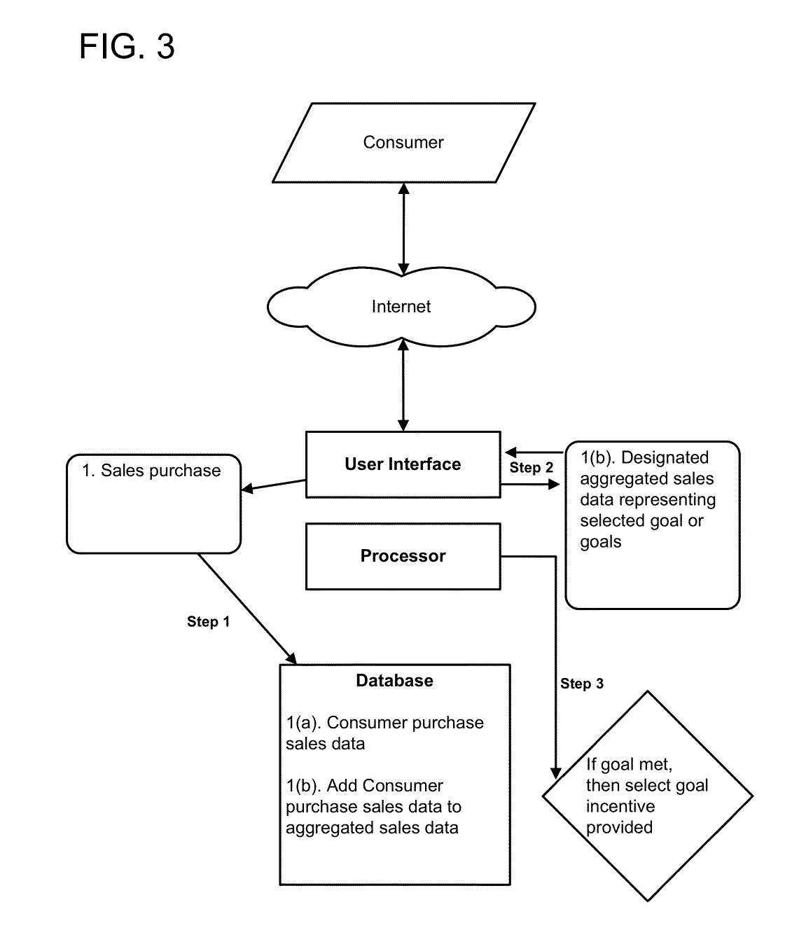

In some embodiments, a sale is initiated based upon more options/parameters, such as one or more options set by an entity/user of the disclosed system and/or method. In one embodiment, a sale is initiated based on time parameters. In one embodiments of the disclosed system, a sale is initiated by the processor component. In some embodiments of the system, stored data for the sale is provided/disclosed to a user interface accessible by one or more users/consumers by a computer system, mobile phone, pad or similar device that connects to the Internet. See FIG. 3. In some embodiments of the system, if a purchase is made then a payment is processed by the system, such as by the processor component. In some embodiments of the system, sales data is provided to the database. In some embodiments, the provided individual sales data and/or aggregated sales data is stored within the database (See Step 1). In some embodiments, the stored sales data (either individual and/or aggregated sales data) is retrieved from the database and provided to the one or more users/consumers in real time. In some embodiments, the stored sales data represents the goal or goals set and the obtainment of the goal or goals is tracked by the system and displayed to the users/consumers, such as by the user interface where it is displayed/updated in real time. See Step 2. In some embodiments, the system provides the consumer with access to the stored digital content that was purchased. In some embodiments, if a selected goal, such as sales goal, is met, then the system can provide the one or more consumers who purchase or purchased previously with access to the incentive that was attributed to the goal. See Step 3.

In some embodiments, the method includes providing an option to upload digital content to a database and/or input data for use to access digital content, such as to access digital content on a separate computer system. The method can further comprise providing one or more options for distributing the digital content. In some embodiments, the providing one or more options for distributing the digital content includes providing an option to set dates and/or time, set price, ability to select a charity to receive a benefit based upon a sale and if so, a particular charity, allocating a percentage of sale revenue to the selected charity and running a top donor competition where donation amounts are dynamically displayed, and set a sales goal, by total units sold, total revenue generated, amount of money raised for charity, the price paid by a user, or an equivalent and defining an incentive that can be released or provided if the goal is met. The method can further comprise storing the data entered, such as storing the dates and/or times, prices, charity selected and percentage of sale revenue to the selected charity and the one or more parameters governing a sales goal (e.g., units sold, sales revenue, or an equivalent thereof). The method can also comprise initiating a sale of the digital content and displaying the stored data for the sale to a user interface, such as a user interface accessible by one or more consumers. The method can further comprise processing payment and providing the individual sales data and/or aggregated sales data to the user interface in real time. The method can include providing access to the stored digital content that was purchased. In some examples, the method includes providing access to stored digital content that was a component of the individual purchase with the possibility of obtaining access to an incentive which may be revealed only upon reaching a sales goal, a charitable contribution goal or a combination thereof. Multiple levels of digital content can be revealed each being driven by sales goals and/or charitable contribution goals being met. For example, the disclosed method is used to run an online promotion of a particular good, service or combination thereof.

In one example, the disclosed method and system are used to set-up a promotion for a given product, service or combination thereof as well as execute the promotion. For example, the method is performed as described above however the options for distributing the digital content are selected by a promoter, such as the entity that is the provider or selected by the provider of the goods and/or services which are the subject of the promotion. For example, the promoter selects the timing of the promotion (e.g., the start and stop time of the promotion), the various goals and the incentives which will be released or provided upon the obtainment of such goals. The method provides an option to purchase entry level online digital content and/or make a charitable contribution, such as to a consumer that is interested in the subject goods and/or services. The method can comprise providing real-time data regarding the aggregated sales to the consumers allowing the consumer to track the status of reaching a set goal and the possibility of reaching the one or more set goals. If enough purchases and/or charitable contributions are made, the method includes displaying a second level incentive to all consumers at the time at which the goal is met, such as to all of the consumers that made the entry level online digital content purchase and/or to all consumers accessing the promotion after the particular goal was met. It is contemplated that multiple levels of incentives can be revealed over the course of a given promotion to the consumers in accordance with the options/parameters set by the promoter. The techniques and solutions described herein can be performed by software, hardware, or both, of a computing environment, such as one or more computing devices. For example, computing devices include server computers, desktop computers, laptop computers, notebook computers, handheld devices, netbooks, tablet devices, mobile devices, PDAs, and other types of computing devices.

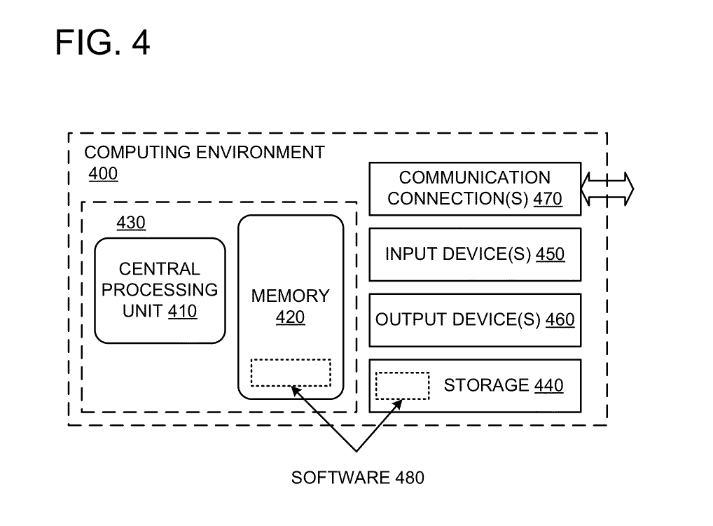

FIG. 4 illustrates a generalized example of a suitable computing environment 400 in which the described technologies can be implemented. The computing environment 400 is not intended to suggest any limitation as to scope of use or functionality, as the technologies may be implemented in diverse general-purpose or special-purpose computing environments. For example, the disclosed technology may be implemented using a computing device comprising a processing unit, memory, and storage, storing computer-executable instructions implementing methods disclosed herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 4, the computing environment 400 includes at least one processing unit 410 coupled to memory 420. In FIG. 4, this basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. The memory 420 can store software 480 implementing any of the technologies described herein.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other computer-readable media which can be used to store information and which can be accessed within the computing environment 400. The storage 440 can store software 480 containing instructions for any of the technologies described herein.

The input device(s) 450 may be a touch input device such as a keyboard, mouse, pen, or trackball, a voice input device, a scanning device, or another device that provides input to the computing environment 400. For audio, the input device(s) 450 may be a sound card or similar device that accepts audio input in analog or digital form, or a CD-ROM reader that provides audio samples to the computing environment. The output device(s) 460 may be a display, printer, speaker, CD-writer, or another device that provides output from the computing environment 400.

The communication connection(s) 470 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

Any of the disclosed methods can be implemented as computer-executable instructions or a computer program product stored on one or more computer-readable storage media (e.g., non-transitory computer-readable media, such as one or more optical media discs such as DVD or CD, volatile memory components (such as DRAM or SRAM, or nonvolatile memory components such as hard drives) and executed on a computer (e.g., any commercially available computer, including smart phones or other mobile devices that include computing hardware). Computer-readable media does not include propagated signals. Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the internet, a wide-area network, a local-area network, a client-server network (such as a cloud computing network), or other such network using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash or any other suitable programming language. Likewise, the disclosed technology is not limited to any particular computer or type of hardware. Certain details of suitable computers and hardware are well known in the art and need not be set forth in detail in this disclosure.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the internet, the World Wide Web, an intranet, cable (including fiber optic cable), magnetic communications, electromagnetic communications (including RF, microwave, and infrared communications), electronic communications, or other such communication means.

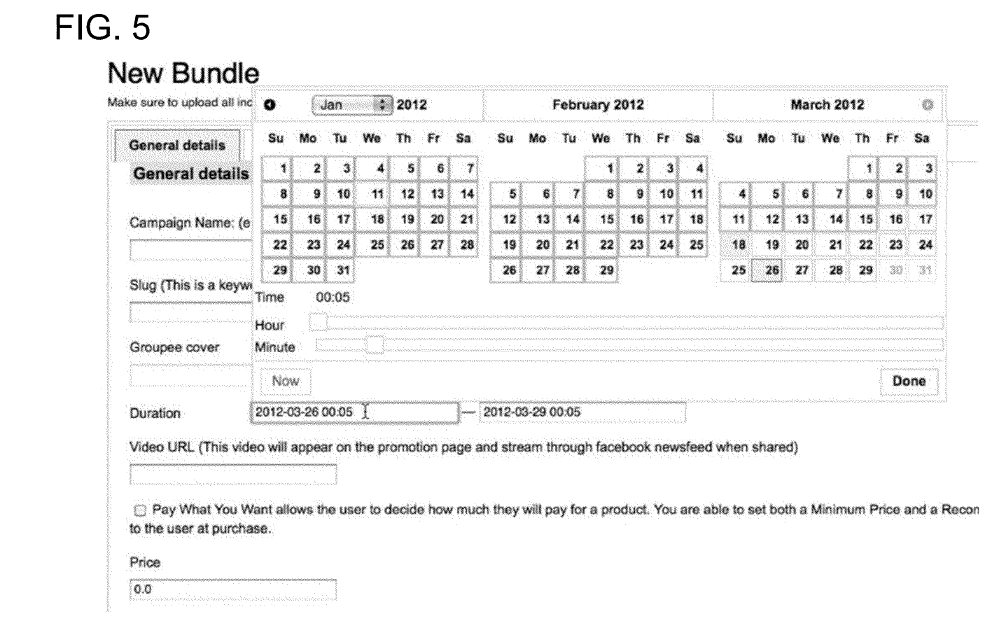

FIG. 5 is a screenshot depicting workflow/interface for scheduling a sale of digital content utilizing the disclosed embodiment. In this example, the method uses standard fields, checkboxes and dropdowns to simplify the process of setting dates/times and pricing, whether fixed price or spay what you want.

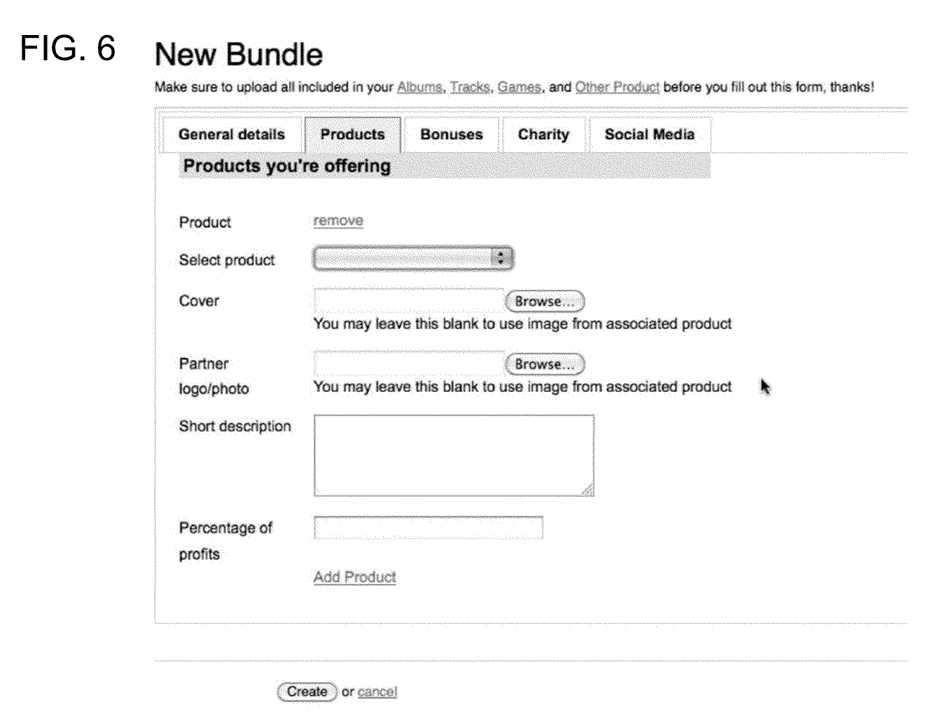

FIG. 6 is a screenshot depicting workflow/interface for uploading digital content associated with a sale utilizing the disclosed embodiment. In this example, the method uses standard fields and dropdowns to simplify the process of uploading and designating digital content for a sale.

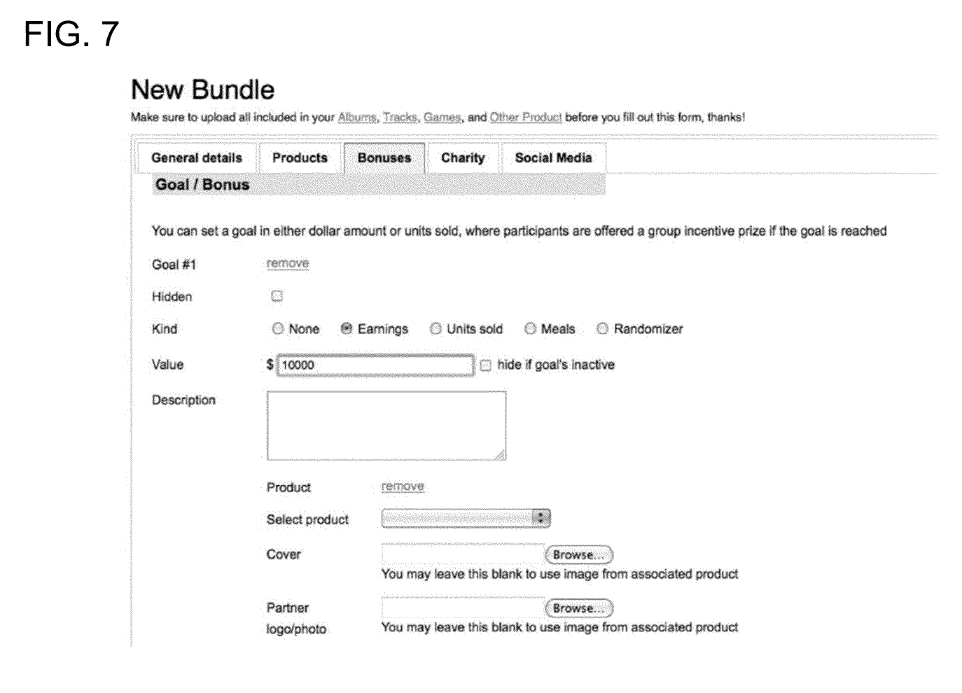

FIG. 7 is a screenshot depicting workflow/interface for setting a sales goal and assigning an incentive to be released or provided when the sales goal is achieved utilizing the disclosed embodiment. In this example, the method uses standard fields, checkboxes and dropdowns to simplify the process of designating a sales goal or goals and assigning an incentive or incentives.

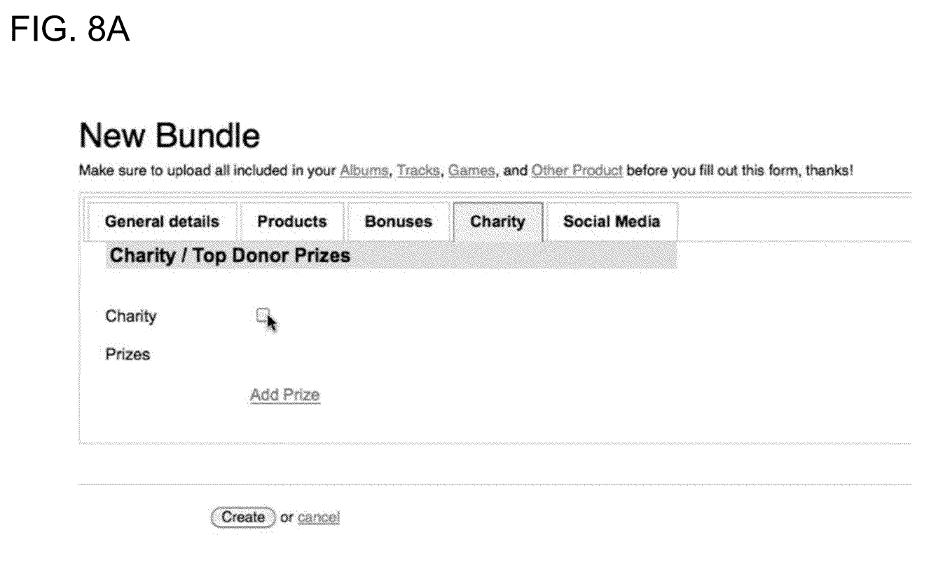

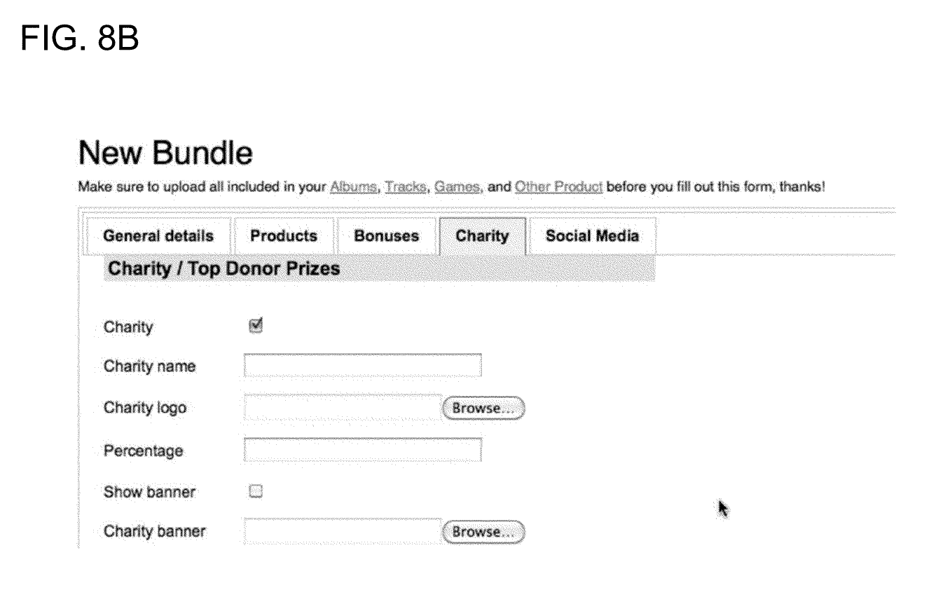

FIG. 8 (a) is a screenshots depicting workflow/interface for selecting whether to include a charity and, if yes, then (b) selecting the charity, the amount to give and whether to include a top donor competition with awards, utilizing the disclosed embodiment. In this example, the method uses standard fields, checkboxes and dropdowns to simplify the process of selecting a charity, the amount to give and whether to include a top donor competition with awards.

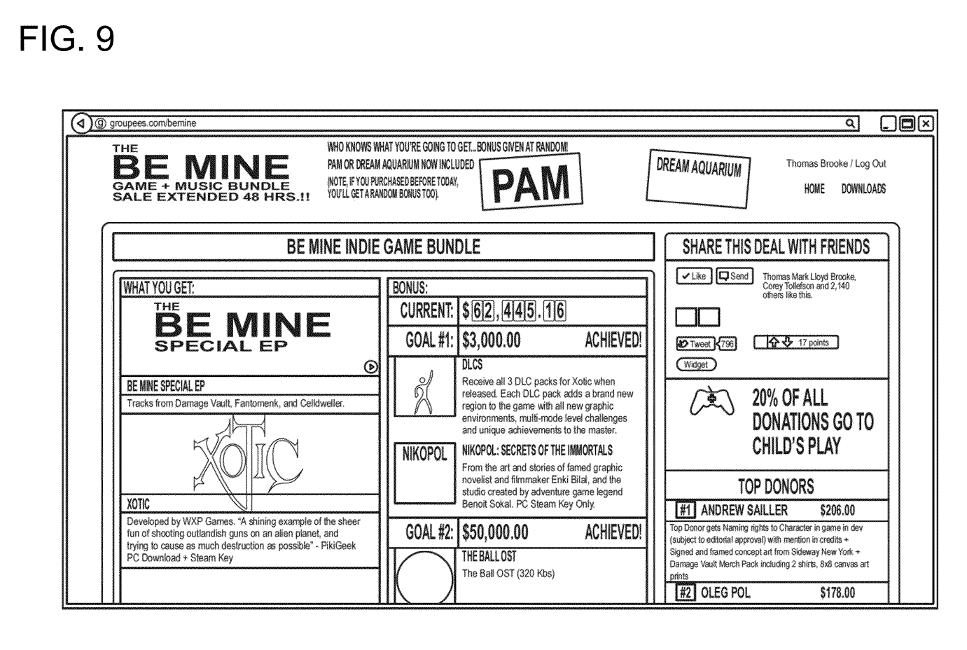

FIG. 9 is a screenshot depicting the published webpage utilizing the disclosed embodiment.

Example Implementation

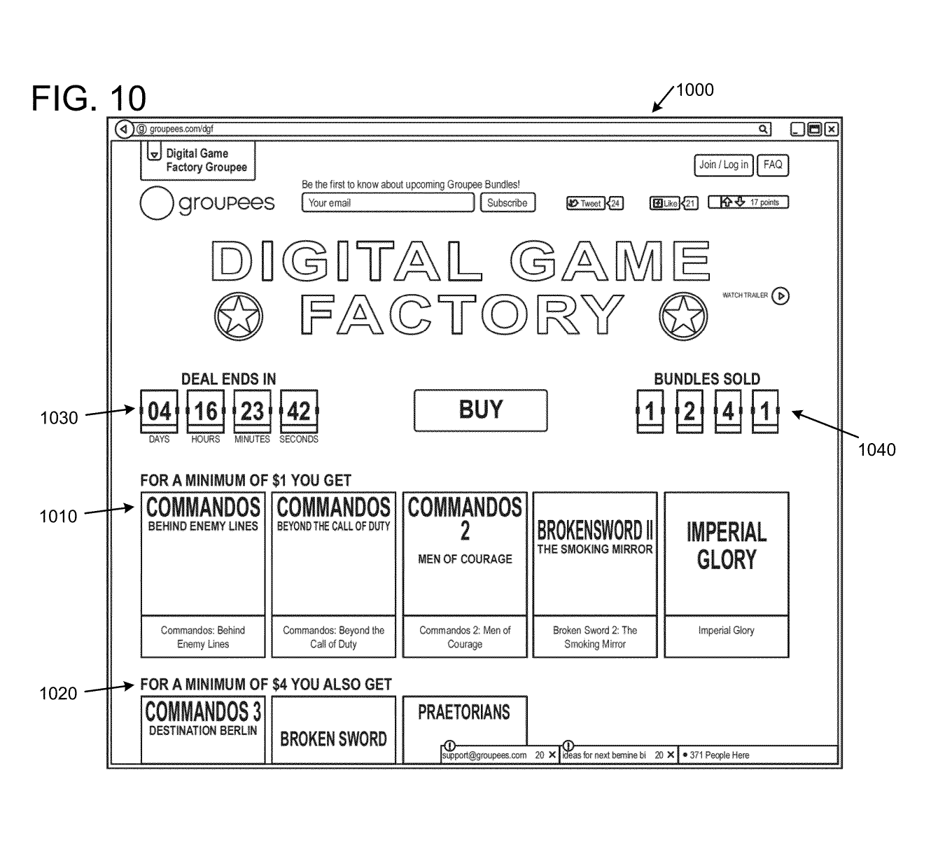

FIGS. 10 through 13 are example screenshots depicting a web page user interface for distributing digital content during an example online promotion. FIG. 10 depicts an example screenshot 1000 of a top portion of the web page. As depicted in the example screenshot 1000, digital content is displayed to users (viewers of the web page) for purchase. The digital content in the example screenshot 1000 is a bundle of computer games, which are divided into a first group of digital content 1010 (5 games in this example) that a purchaser will receive if the purchaser pays at least $1, and a second group of digital content 1020 (3 games in this example) that the purchaser will receive (in addition to the first group of digital content) if the purchaser pays at least $4. Other information about the promotion is displayed in the example screenshot 1000, including the amount of time left in the online promotion 1030 and the number of units of the digital content that have been sold so far 1040, which are examples of sales data that is dynamically displayed to users of the web page so that the users can track the progress of the promotion (e.g., in real time).

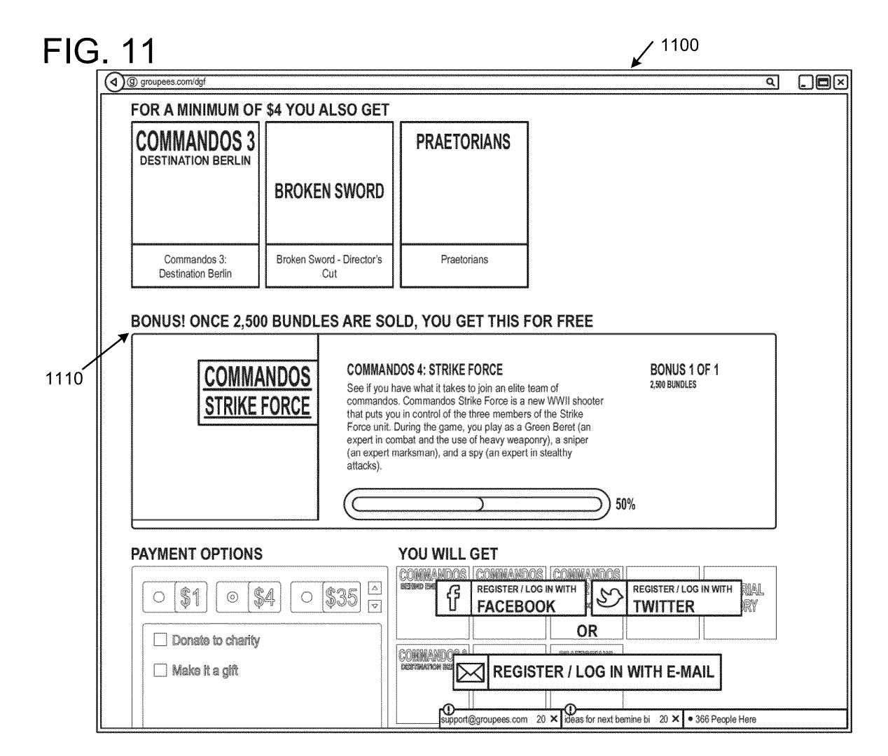

FIG. 11 depicts an example screenshot 1100 of a middle portion of the web page. As depicted in the example screenshot 1100, a sales goal is displayed 1110. The sales goal in this example is a number of units sold of the digital content game bundle (2,500 bundles). Once the sales goal has been reached (in this example, once 2,500 units have been sold), purchasers will receive additional digital content (an additional computer game in this example). Progress toward the sales goal is indicated by the current number of units that have been sold (1,241 units, as depicted at 1040) as well as the progress bar at 1110.

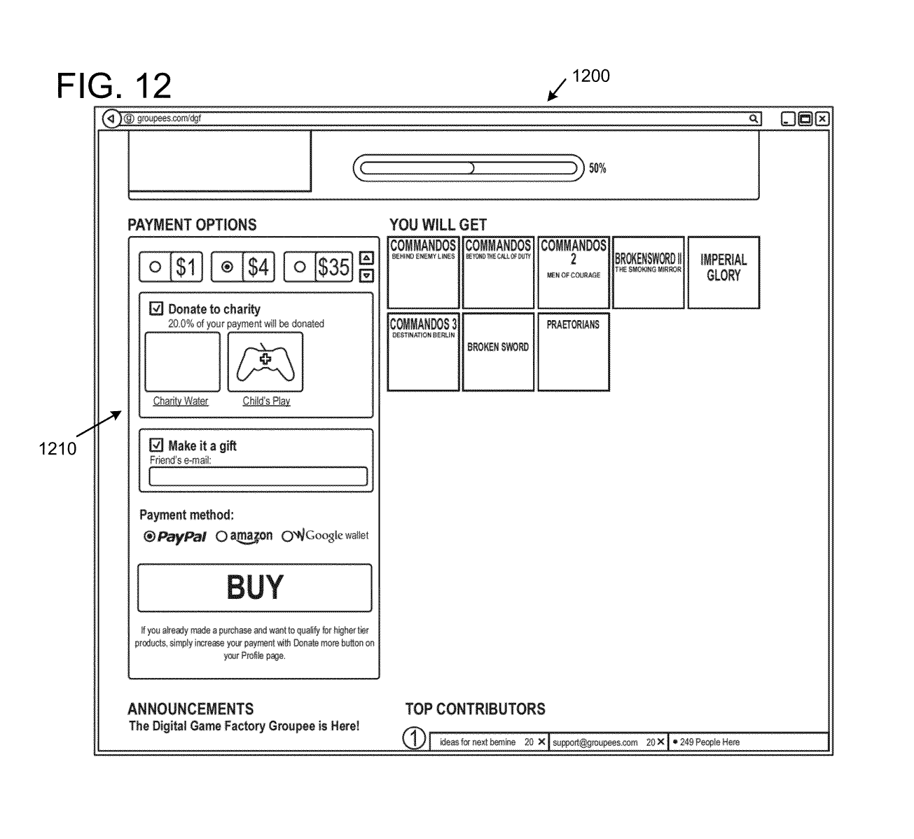

FIG. 12 depicts an example screenshot 1200 of the middle portion of the web page, which is the lower part of the example screenshot 1100 but with the payment options area 1210 displayed. For example, the payment options area 1210 can be displayed in response to the user logging in to enable the user to make a purchase. As depicted in the payment options area 1210, the user can select what the user wants to pay. In this example promotion, the user can select to pay $1, $4, or the user can enter another amount. As depicted in the payment options area 1210, the user can also select to donate a portion of the payment price to charity (in this example, 20% will be donated to the listed charities if the check box is selected).

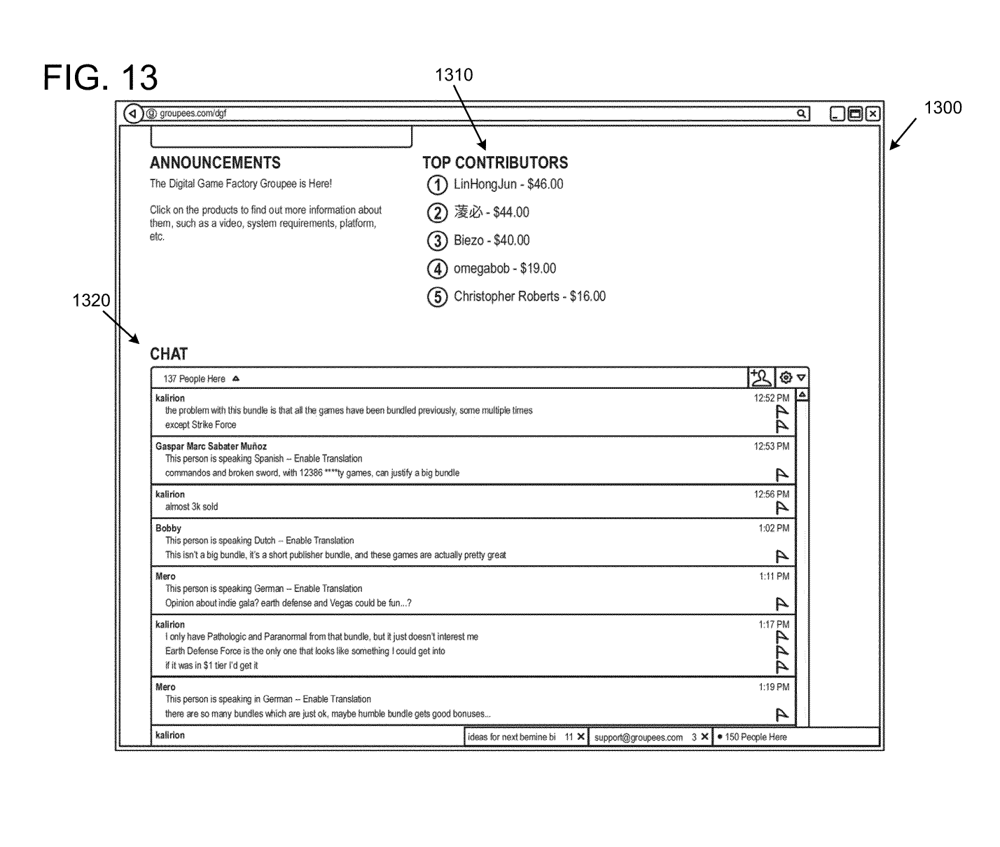

FIG. 13 depicts an example screenshot 1300 of the bottom portion of the web page. As depicted in the example screenshot 1300, a list of top contributors is displayed 1310 along with the amounts contributed by each of the top contributors. Also displayed in the example screenshot 1300 is a chat window 1320. The chat window 1320 allows users to discuss the promotion (e.g., post messages and comments in real-time). The chat window 1320 can be visible to all viewers of the promotion web page.

Definitions

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

Additionally, the description sometimes uses terms like “produce” and “provide” to describe the disclosed methods. These terms are high-level abstractions of the actual computer operations that are performed. The actual computer operations that correspond to these terms will vary depending on the particular implementation and are readily discernible by one of ordinary skill in the art.

Alternatives

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

In view of the many possible embodiments to which the principles of the disclosed invention may be applied, it should be recognized that the illustrated embodiments are only preferred examples of the invention and should not be taken as limiting the scope of the invention.

I claim:

1. A method, implemented at least in part by a computing device, for providing an online promotion for digital content, the method comprising:
by the computing device:
displaying digital content for purchase by users, wherein the digital content is displayed during a promotion of the digital content, the promotion having a start date and an end date;
dynamically displaying current sales data for the promotion of the digital content;
displaying a sales goal associated with the promotion of the digital content; and
displaying an incentive associated with the sales goal, wherein the incentive is provided to purchasers of the digital content when the sales goal has been reached.

2. The method of claim 1, wherein dynamically displaying current sales data comprises:
dynamically displaying total units of the digital content that have been sold;
dynamically displaying total amount paid by purchasers of the digital content; and
dynamically displaying average amount paid by the purchasers of the digital content;
wherein the current sales data is displayed in real-time.

3. The method of claim 1, further comprising:
determining whether the sales goal has been reached;
when the sales goal has been reached, providing the incentive associated with the sales goal to all purchasers of the digital content during the promotion.

4. The method of claim 1, wherein the incentive is additional digital content.

5. The method of claim 1, wherein the incentive comprises one or more of:
additional digital content;
streaming video content; and
a digital coupon.

6. The method of claim 1, wherein the sales goal is a number of units sold of the digital content.

7. The method of claim 1, wherein the sales goal is one of:
a goal number of units sold of the digital content;
a goal amount of revenue generated; and
a goal amount of revenue raised for charity.

8. The method of claim 1, wherein the sales goal is a first-level sales goal, the method further comprising:
determining whether the first-level sales goal has been reached;
when the first-level sales goal has been reached:
displaying a second-level sales goal and a second incentive associated with the second-level sales goal.

9. The method of claim 1, further comprising:
dynamically displaying one or more top donors; and
for each top donor of the displayed one or more top donors:
dynamically displaying an amount paid by the top donor; and
displaying a prize associated with the top donor.

10. The method of claim 1, wherein the digital content for purchase comprises a plurality of digital content products, wherein the plurality of digital content products comprise digital game content and/or digital music content.

11. The method of claim 1, wherein the current sales data for the promotion is dynamically displayed to viewers of the digital content in real-time as purchases occur during the promotion.

12. The method of claim 1, wherein the digital content, the current sales data, the sales goal, and the incentive are displayed on a web page during the promotion.

13. The method of claim 1, further comprising, for each of one or more purchasers of the digital content:
processing payment for a purchase of the digital content by the purchaser;
providing the digital content purchaser; and
aggregating sales data from the purchase for display in real-time.

14. A method, implemented at least in part by a computing device, for providing an online promotion for digital content, the method comprising:
by the computing device, receiving promotion information for creating the online promotion comprising:
receiving a time period for the promotion comprising a start date and an end date;
receiving a pricing option, wherein the pricing option is selected from a fixed price option and a pay what you want option;
receiving an indication of whether a charity is included;
receiving a sales goal associated with the promotion of the digital content; and
receiving an incentive associated with the sales goal, wherein the incentive will be provided to purchasers of the digital content when the sales goal has been reached; and
storing, by the computing device in a database, the promotion information.

15. The method of claim 14, wherein a charity is included in the promotion, the method further comprising:
receiving a selection of the charity;
receiving an indication of a percentage of revenue for the charity;
receiving a selection of a top donor competition; and
receiving an indication of a prize associated with the top donor competition.

16. The method of claim 14, wherein the incentive is additional digital content.

17. The method of claim 14, wherein the sales goal is a number of units sold of the digital content.

18. The method of claim 14, wherein the sales goal is one of:
a goal number of units sold of the digital content;
a goal amount of revenue generated; and
a goal amount of revenue raised for charity.

19. A computer-readable storage medium storing computer-executable instructions for causing a computing device to perform a method for providing an online promotion for digital content, the method comprising:
displaying digital content for purchase by users, wherein the digital content is displayed during a promotion of the digital content, the promotion having a start date and an end date;
dynamically displaying current sales data for the promotion of the digital content;
displaying a sales goal associated with the promotion of the digital content; and
displaying an incentive associated with the sales goal, wherein the incentive is provided to purchasers of the digital content when the sales goal has been reached.

20. The computer-readable storage medium of claim 19, the method further comprising:
displaying, in real-time, a chat window for dynamically receiving and displaying messages associated with the promotion from users.
